(19) United States
(12) Patent Application Publication
(10) Pub. No.: US 2010/0268534 A1
(43) Pub. Date: Oct. 21, 2010

(54) TRANSCRIPTION, ARCHIVING AND THREADING OF VOICE COMMUNICATIONS

(75) Inventors: ALBERT JOSEPH KISHAN THAMBIRATNAM, BEIJING (CN); FRANK TORSTEN BERND SEIDE, BEIJING (CN); PENG YU, REDMOND, WA (US); ROY GEOFFREY WALLACE, BRISBANE (AU)

Correspondence Address: MICROSOFT CORPORATION, ONE MICROSOFT WAY, REDMOND, WA, 98052, US

(73) Assignee: MICROSOFT CORPORATION, REDMOND, WA (US)

(21) Appl. No.: 12/425,841

(22) Filed: Apr. 17, 2009

(51) Int. Cl. G10L 15/26; G10L 17/00

(52) U.S. Cl. 704/235; 704/246; 704/E15.043

(57) ABSTRACT

Described is a technology that provides highly accurate speech-recognized text transcripts of conversations, particularly telephone or meeting conversations. Speech is received for recognition when it is at a high quality and separate for each user, that is, independent of any transmission. Moreover, because the speech is received separately, a personalized recognition model adapted to each user's voice and vocabulary may be used. The separately recognized text is then merged into a transcript of the communication. The transcript may be labeled with the identity of each user that spoke the corresponding speech. The output of the transcript may be dynamic as the conversation takes place, or may occur later, such as contingent upon each user agreeing to release his or her text. The transcript may be incorporated into the text or data of another program, such as to insert it as a thread in a larger email conversation or the like.

### BACKGROUND

Voice communication offers the advantage of instant, personal communication. Text is also highly valuable to users because unlike audio, text is easy to store, search, read back and edit, for example.

Few systems offer to record and archive phone calls, and even fewer provide a convenient means to search and browse previous calls. As a result, numerous attempts have been made to convert voice conversations to text transcriptions so as to provide the benefits of text for voice data.

However, while speech recognition technology is sufficient to provide reasonable accuracy levels for dictation, voice command and call-center automation, the automatic transcription of conversational, human-to-human speech into text remains a technological challenge. There are various reasons why transcription is challenging, including that people often speak at the same time; even only briefly overlapping speech, such as to acknowledge agreement, may severely impact recognition accuracy. Echo, noise and reverberations are common in a meeting environment.

When attempting to transcribe telephone conversations, low bandwidth telephone lines also cause recognition problems, e.g., the spoken letters “f” and “s” are difficult to distinguish over a standard telephone line. Audio compression that is often used in voice transmission and/or audio recording further reduces recognition accuracy. As a result, such attempts to transcribe telephone conversations have accuracies as low as fifty-to-seventy percent, limiting their usefulness.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which speech from communicating users is separately recognized as text of each user. The recognition is performed independent of any transmission of that speech to the other user, e.g., on each user's local computing device. The separately recognized text is then merged into a transcript of the communication.

In one aspect, speech is received from a first user who is speaking with a second user. The speech is recognized independent of any transmission of that speech to the second user (e.g., on a recognition channel that is independent of the transmission channel). Recognized text corresponding to speech of the second user is obtained and merged with the text of the first user into a transcript. Audio from separate streams may also be merged.

The transcript may be output, e.g., with each set of text labeled with the identity of the user that spoke the corresponding speech. The output of the transcript may be dynamic (e.g., live) as the conversation takes place, or may occur later, such as contingent upon each user agreeing to release his or her text. The transcript may be incorporated into the text or data of another program, such as to insert it as a thread in a larger email conversation or the like.

In one aspect, the recognizer uses a recognition model for the first user that is based upon an identity of the first user, e.g., customized to that user. The recognition may be performed on a personal computing device associated with that user.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components in a communications environment that provides speech-recognized text transcriptions of voice communications to users.

FIG. 2 is a block diagram showing example components in a communications and/or meeting environment that provides speech-recognized text transcriptions of voice communications to users.

FIG. 3A is a representation of a user interface in which speech-recognized text is dynamically merged into a transcription.

FIG. 3B is a representation of a user interface in which speech-recognized text is transcribed for one user while awaiting transcribed text from one or more other users.

FIG. 4A is a flow diagram showing example steps that may be taken to dynamically merge speech-recognized text into a transcription.

FIG. 4B is a flow diagram showing example steps that may be taken to merge speech-recognized text into a transcription following user consent.

FIG. 5 shows an illustrative example of a computing environment into which various aspects of the present invention may be incorporated.

### DETAILED DESCRIPTION

Various aspects of the technology described herein are generally directed towards providing text transcripts of conversations that have a much higher recognition accuracy than other models, in general by obtaining the speech for recognition when it is at a high quality and distinct for each user, and/or by using a personalized recognition model that is adapted to each user's voice and vocabulary. For example, computer-based VoIP (Voice over Internet Protocol) telephony offers a combination of high-quality, channel-separated audio, such as via a talking headset microphone or USB-handset microphone, and access to uncompressed audio. At the same time, the user's identity is known, such as by having logged into the computer system or network that is coupled to the VoIP telephony device or headset, and thus a recognition model for that user may be applied.

To provide a transcript, the independently recognized speech of each user is merged, e.g., based upon timing data (e.g., timestamps). The merged transcript is able to be archived, searched, copied, edited and so forth as is other text. The transcript is also able to be used in a threading model, such as to integrate the transcript as a thread in a chain of email threads.

While some of the examples described herein are directed towards VoIP telephone call transcription, it is understood that these are non-limiting examples; indeed, “VoIP” as used herein refers to VoIP or any equivalent. For example, users may wear highly-directional headset microphones in a meeting environment, whereby sufficient quality audio may be obtained to provide good recognition. Further, even with a conventional telephone, each user's audio may be separately captured before transmission, such as via a dictation-quality microphone coupled to or proximate to the conventional telephone mouthpiece, whereby the recognized speech is picked up at high quality, independent of the conventional telephone's transmitted speech. High-quality telephone standards also exist that allow the transmission of a high-quality voice signal for remote recognition. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and communications technology in general.

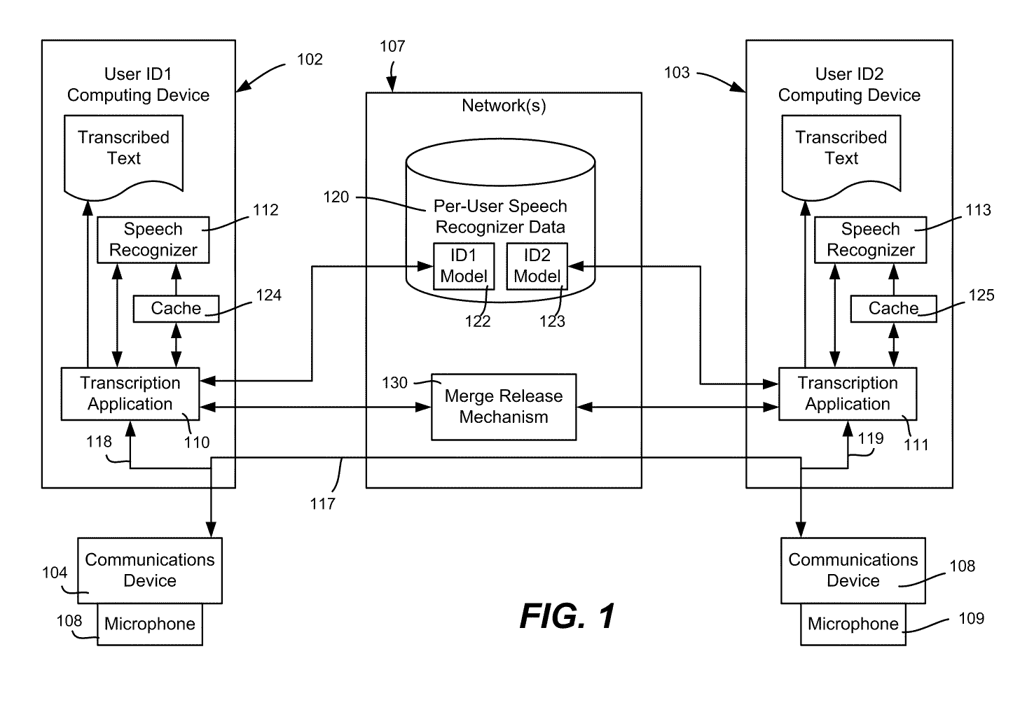

Turning to FIG. 1, there is shown an example computing and communications environment in which users communicate with one another and receive a text transcription of their communication. Each user has a computing device 102 and 103, respectively, which may be a personal computer, or a device such as a smart phone, special phone, personal digital assistant, and so forth. As can be readily appreciated, more than two users may be participating in the conversation. Further, not all users in the conversation need to be participating in the transcription process.

One or both of the exemplified computing devices 102 and 103 may be personal computers such as desktops, laptops and so forth. However more dedicated devices may be used, such as to build transcription functionality into a VoIP telephone device, a cellular telephone, a transcription “appliance” in a meeting room (such as within a highly directional microphone array or a box into which participants each plug in a headset), and so forth.

In one implementation, the users communicate with one another via a respective communications device 104 and 105, such as a VoIP telephone, in a known manner over a suitable network 107 or other communications medium. As represented in FIG. 1, microphones 108 and 109 (which may be a headset coupled to each respective computing device or a separate microphone) detect the audio and provide the audio to a transcription application 110 and 111, respectively, which among other aspects, associates a timestamp or the like with each set of audio received. The speech in the audio is then recognized as text by respective recognizers 112 and 113. Note that it is feasible to have the recognition take place first, with the results of the recognition fed to the transcription application, however there may be various advantages to have the transcription application receive the audio (or at least known when each set of speech starts and stops), e.g., so that recognition delays and other issues do not cause problems with the timestamps, and so forth.

Significantly, in one implementation the recognition of the speech takes place independent of any transmission of the speech over a transmission/communications channel 117, that is, on a recognition channel 118 or 119 that is separate for each user and independent from the communications channel 117, e.g., before transmission or basically simultaneous with transmission. Note that in general there is initially a single channel (the microphone input), which is split up into two internal digital streams, one going to the communications software and one to the recognizer. This has numerous advantages, including that some communication media such as a conventional telephone line or cellular link has noise and bandwidth limitations that reduce recognition accuracy. Further, audio compression may be used in the transmission, which is not lossless when decompressed and thus also reduces recognition accuracy.

Still further, the distribution of the recognition among separate computing devices provides additional benefits, including that recognition operations do not overwhelm available computing power. For example, prior systems (in which conversation recognition for transcription was attempted for all users at the network or other intermediary service) were unable to handle many conversations at the same time. Instead, as exemplified in FIG. 1, the recognition tasks are distributed among contemporary computing devices that are easily able to provide the computational power needed, while also performing other computing tasks (including audio processing, which consumes relatively very little computational power).

As another benefit, having a computing device associated with each user facilitates the use of a customized recognition model for each user. For example, a user may have previously trained a recognizer with model data for his or her personal computer. A shared computer knows its current user's identity (assuming the user logged in with his or her own credentials), and can thus similarly use a customized recognition model. Instead of or in addition to direct training, the personalized speech recognizer may continuously adapt to the user's voice and learn/tune his or her vocabulary and grammar from e-mail, instant messaging, chat transcripts, desktop searches, indexed document mining, and so forth. Data captured during other speech recognition training may also be used.

Still further, having a computing device associated with each user helps maintain privacy. For example, there is no need to transmit personalized language models, which may have been built from emails and other content, to a centralized server for recognition.

Personalized speech recognition is represented in FIG. 1, which shows per-user speech recognizer data 120 as respective models 122 and 123 for each user. Note that this data may be locally cached in caches 124 and 125, and indeed, the network 107 need not store this data for personal users; (FIG. 1 is only one example showing how shared computer users can have their customized speech data loaded as needed, such as from a cloud service or an enterprise network). Thus, it is understood that that the network storage shown in FIG. 1 is optional and if present may be separate for each user, as well as a separate network with respect to the communications transmission network.

In this manner, the transcription applications 110 and 111 can obtain text recognized from high quality speech, providing relatively high recognition accuracy. Each transcription application (or a centralized merging application) may then merge the separately recognized speech into a transcript. Note that the speech is associated with timestamps or the like (e.g., start and stop times) to facilitate merging, as well as provide other benefits such as finding a small portion of speech within an audio recording thereof. For example, the transcript may be clickable to jump to that point in the audio. The transcript is labeled with each user's identity, or at least some distinguishing label for each speaker if unknown (e.g., “Speaker 1” or “Speaker 2”).

The speech may be merged dynamically and output as a text transcript to each user as soon as it is recognized, somewhat like closed captioning, but for a conversation rather than a television program. Such a live display allows distracted multi-tasking users or non-native speakers to better understand and/or catch-up on any missed details. However, in one alternative described below, text is only merged when the users approve merging, such as after reviewing part or all of the text. In such an alternative, a merge release mechanism 130 (e.g., on the network 107 or some other service) may be used so as to only release the text to the other party for merging (or as a merged transcript, such as sent by email) when each user agrees to release it, which may be contingent upon all parties agreeing. Note that one implementation of the system also merges audio into a single audio stream for playback from the server, such as when clicking on the transcript.

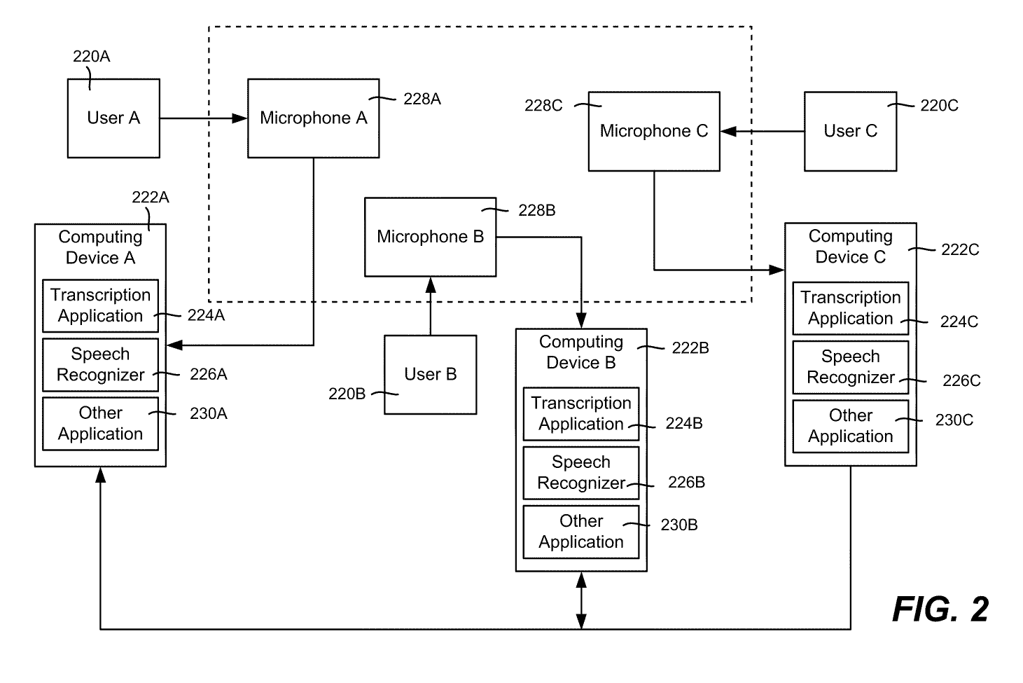

Alternatively, instead of or in addition to a communications network, two or more of the users may directly hear each other's speech, such as in a meeting room. A transcription that serves as a source of minutes and/or a summary of the meeting is one likely valuable use of this technology. FIG. 2 exemplifies such a scenario, with three users 220A, 220B and 220C communicating, whether by direct voice, amplified voice or over a communications device. In such a scenario, the same computer can process the speech of two or three users; thus while three computing devices 222A-222C are shown in FIG. 2, each with separate transcription applications 224A-224C and recognizers 226A-226C, FIG. 2 exemplifies only one possible configuration. Note that the audio of two or more speakers may be down-mixed into a single channel, although this may lose some of the benefits, e.g., personalized recognition may be more difficult, overlapping speech may be present, and so forth. The technology herein also may be implemented in a mixed-mode scenario, e.g., in which one or more callers in a conference call communicate over a conventional telephone line.

Notwithstanding, having separate microphones 228-228C provides significant benefits as described herein, such as avoiding background noise, and allowing a custom recognition model for each user. Note that the microphones may actually be a microphone array (as indicated by the dashed box) that is highly directional for each direction and thus acts to an extent as a separate microphone/independent recognition channel for each user.

With respect to determining each user's identity, various mechanisms may be used. In the configuration of FIG. 1, a user's identity is known from logging on to the computing device. In a configuration such as FIG. 2, in which a computing device may not belong to the user, a user may alternatively provide his or her identity directly, such as by typing in a name, speaking a name, and so forth. Each user's identity may be then recognized, possibly with help from an external (other) application 230A-230C such as Microsoft® Outlook®, which knows who is scheduled to participate in a meeting, and can inform each recognizer which one of the users is using that particular recognizer even if recognition is not highly accurate because the user's identity first needs to be determined.

As another alternative, parallel recognition models may operate (e.g., briefly) to determine which model gives the best results for each user. This may be narrowed down by knowing a limited number of participants, for example. Various types of user models may be employed for unknown users, keeping the one with the best results. The parallel recognition (temporarily) may be centralized, with a model downloaded or selected on each personal computer system; for example, a brief introductory speech by each user at the beginning of each conversation may allow an appropriate model to be selected.

In addition to the assistance given by an application 230A-230C in determining user identities, applications may be configured to incorporate aspects of the transcripts therein. For example, written call transcripts may be searched. As another example, written call transcripts (automatically generated with the users' consent as needed) may be unified with other text communication, such as seamlessly threaded with e-mail, instant messaging, document collaboration, and so forth. This allows users to easily search, archive and/or recount telephone or other recorded conversations. An application that provides a real-time transcript of an ongoing teleconference helps non-native speakers and distracted multi-tasking participants.

As another email example, consider that e-mail often requires follow-up, which may be in the form of a telephone call rather than an e-mail. A “Reply by Phone” button in an email application can be used to trigger the transcription application (as well as the telephone call), which then transcribes the conversation. After (or possibly during) the call, the user automatically receives the transcript by e-mail, which retains the original subject and e-mail thread, and becomes part of the thread in follow-up e-mails. Note that email is only one example, as a unified communications program may include the transcript among emails, instant messages, internet communications, and so forth.

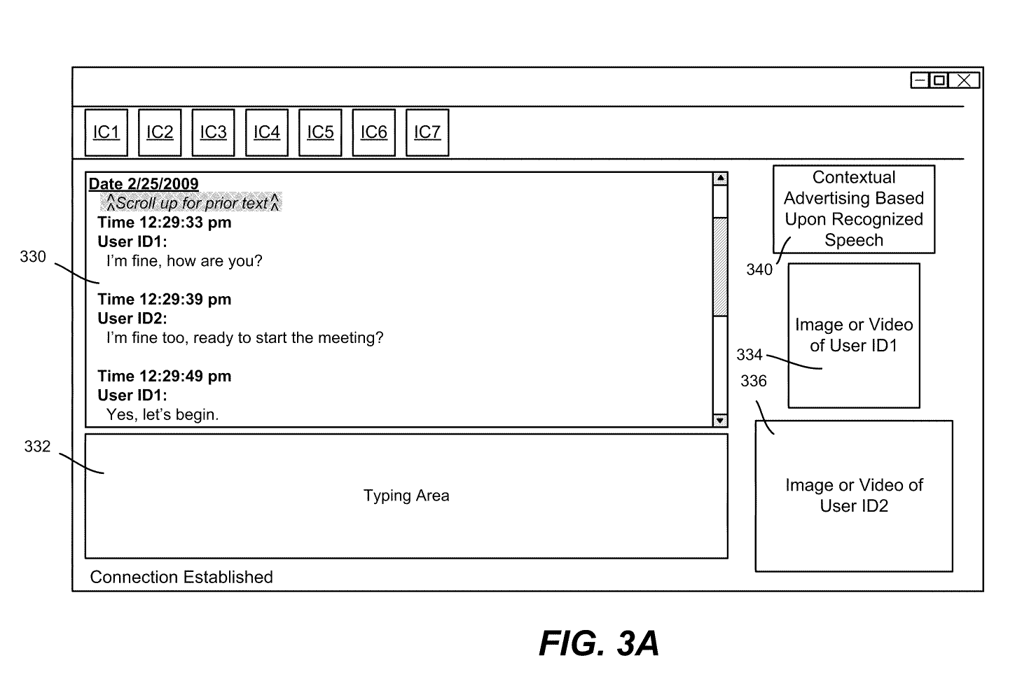

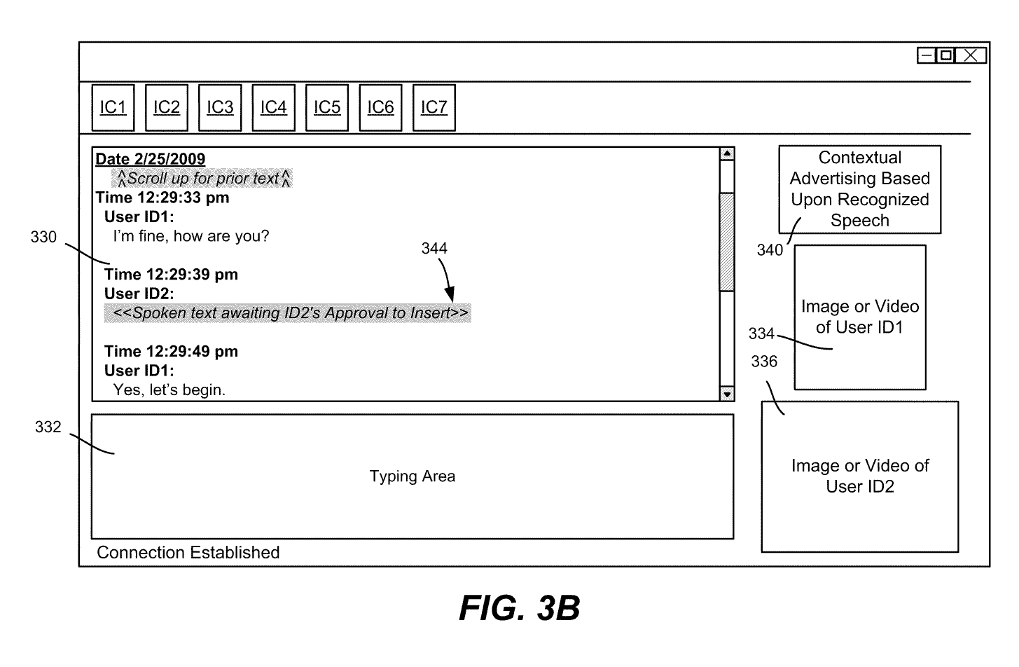

FIGS. 3A and 3B show various aspects of transcription in an example user interface. In FIG. 3A, the transcription is live; note that this may require consent by users in advance. In any event, as a user speaks, recognition takes place, the user's recognized text is displayed locally and the recognized text sent to the other user. The other user's recognized speech is received as text, and merged and displayed as it is received, e.g., in a scrollable transcription region 330. Note that the text of each user is labeled by each user's identity, however other ways to distinguish the text may be helpful, such as different colors, highlighting, fonts, character sizes, bolding, italicizing, indentation, columnar display, and so forth. Further note that recognition data may be sent along with the text, so that, for example, words recognized with low confidence may be visually marked up as such (e.g., underlined similar to misspelled words in a contemporary word processor).

Various icons (e.g., IC1-IC7) may be provided to offer different functions, modes and so forth to the user. A typing area 332 may be provided, which may be private, shared with the other user, and so forth. Via areas 334 and 336, each participant may have an image or live camera video shown to further facilitate communication. The currently speaking user (or a selected view such as a group view or view of a whiteboard) may be displayed, such as when more participants than display areas are available.

Also exemplified in FIG. 3A is an advertisement area 340, which, for example, may show targeted contextual advertisements based upon the transcript, e.g., using keywords extracted therefrom. Participants may receive free or reduced-price calls funded by such advertising to incentivize users' consent. Note that in addition to or instead of contextual advertising shown during a phone call, advertisements may be sent (e.g., by e-mail) after the call.

FIG. 3B is similar to FIG. 3A except that additional privacy is provided, by needing consent to release the transcript after the conversation or some part thereof concludes, instead of beforehand (if consent is used at all) as in dynamic live transcription. One difference in FIG. 3B from FIG. 3A is a placeholder 344 that marks the other user's transcribed speech as having taken place, but not yet being available, awaiting the other user's consent to obtain it.

This addresses privacy because each user's own voice is separately recognized, and in this mode users need to explicitly opt-in to share their transcription side with others. User's may review (or have a manager/attorney review) their text before releasing, and the release may be a redacted version. A section of transcribed speech that is removed or changed may be simply removed, or marked as intentionally deleted or changed. A user may make the release contingent on the other user's release, for example, and the timestamps may be used to match each user's redacted parts to the other's redacted parts for fairness in sharing.

To help maintain context and for other reasons, the actual audio may be recorded and saved, and linked to by links embedded in the transcribed text, for example. Note that the audio recording may have a single link thereto, with the timestamps used as offsets to the appropriate time of the speech. In on implementation, the transcript is clickable, as each word is time-stamped (in contrast to only the utterance). Via interaction with the text, the text or any part thereof may be copied and forwarded along with the link (or link/offset/duration) to another party, which may then hear the actual audio. Alternatively, the relevant part of the audio may be forwarded as a local copy (e.g., a file) with the corresponding text.

Another type of interaction may tie the transcript to a dictionary or search engine. For example, by hovering the mouse pointer over a transcript, foreign language dictionary software may provide instant translations for the hovered-over word (or phrase). As another example, the transcript can be used as the basis for searches, e.g., recognized text may be automatically used to perform a web search, such as by hovering, or highlighting and double-clicking, and so forth. User preferences may control the action that is taken, based upon on the user's type of interaction.

Turning to another aspect, the transcribed speech along with the audio may provide a vast source of data, such as in the form of voice data, vocabulary statistics and so forth. Note that contemporary speech training data is relatively limited compared to the data that may be collected from millions of hours of data and millions of speakers. User-adapted speech models may be used in a non-personally-identifiable manner to facilitate ever-improving speech recognition. Access to users' call transcripts, if allowed by users (such as for anonymous data mining), provides rich vocabularies and grammar statistics needed for speech recognition and topic-clustering based approaches. Note that users may want to upload their statistics, such as to receive or improve their own personal models; for example, speech recognized at work may be used to recognize speech on a home personal computer, or automatically be provided to a command-and-control appliance.

Further, a user may choose to store a recognition model in a cloud service or the like, whereby the recognition model may be used in other contexts. For example, a mobile phone may access the cloud-maintained voice profile in order to perform speech recognition for that user. This alleviates the need for other devices to provide speech model training facilities; instead, other devices can simply use a well-trained model (e.g., trained from many hours of the speaker's data) and run recognition. Another example is using this on a home device, such as DVD player, for natural language control of devices. A manufacturer only needs to embed a recognizer to provide speech capabilities, with no need to embed facilities for storing and/or training models.

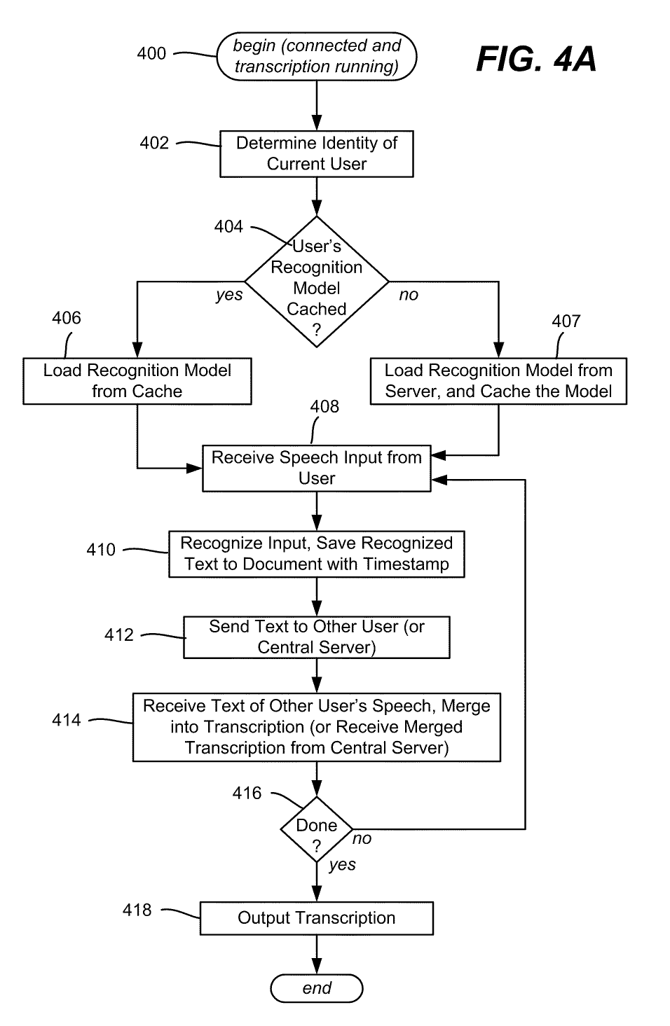

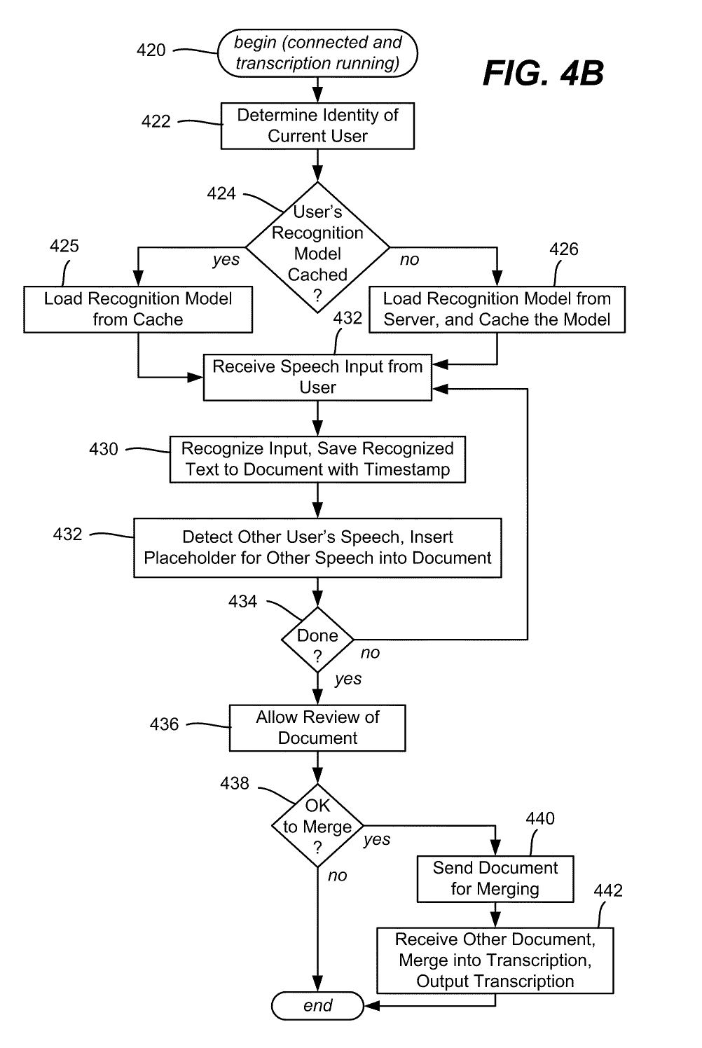

FIGS. 4A and 4B summarize various examples and aspects described above. In general, FIG. 4A corresponds to dynamic, live transcription merging as in FIG. 3A, while FIG. 4B corresponds to transcription merging after consent, as in FIG. 3B.

Step 400 of FIG. 4A represents starting the transcription application and recognizer and establishing the audio connection. Step 402 represents determining the current user identity, typically from logon data, but possibly from other means such as user action, or guessing to narrow down possible users based on meeting invitees, and so on as described above. Steps 404, 406 and 407 obtain the recognition model for this user, e.g., from the cache (step 406) or a server (step 407, which may also cache the model locally in anticipation of subsequent use). Note that various other alternatives may be employed, such as to recognize with several, more general recognition models in parallel, and then select the best model in terms of results, particularly if no user-specific model is available or the user identity is unknown.

Step 408 represents receiving the speech of the user on that user's independent recognition channel. Step 410 represents recognizing the speech into text, and saving it to a document (or other suitable data structure) with an associated timestamp. A start and stop time may be recorded, or a start time, duration pair, so that any user silence may be handled, for example.

Step 412 is part of the dynamic merge operation, and sends the recognized text to the other participant or participants. Instant messaging technology and the like provides for such a text transmission, although it is also feasible to insert text into the audio stream for extraction at the receiver. Similarly, step 414 represents receiving the text from the other user or users, and dynamically merging it into the transcript based on its timestamp data. An alternative is for the clients to upload their individual results to a central server, which then handles merging. Merging can be done for both the transcript and the audio.

Step 416 continues the transcription process until the user ends the conversation, such as by hanging up, or turning off further transcription. Note that a transcription application that can be turned off and on easily allows users to speak off the record as desired; step 416 may thus include a pause branch or the like (not shown) back to step 408 after transcription is resumed.

When the transcription application is done, the transcription may be output in some way. For example, it may become part of an email chain as described above, saved in conjunction with an audio recording, and so forth.

In one aspect, an email may be generated, such as to all parties involved, which is possible because the participants of the call are known. Additionally, if the subject of the call is known (for example in Microsoft® Outlook, starting a VoIP call via Office Communicator® adds the subject of the email to the call), then the email may include the associated subject. In this way, the transcript and previous emails or instant messaging chats may be threaded within the inbox of the users, for example.

FIG. 4B represents the consent-type approach generally corresponding to FIG. 3B. The steps shown in FIG. 4B up to and including step 430 are identical or at least similar to those of FIG. 4A up to and including step 410, and are not described again herein for purposes of brevity.

Step 432 represents detecting the other user's speech, but not necessarily attempting to recognize that speech. Instead, a placeholder is inserted to represent that speech until it is received from the other user (if ever). Note that it is feasible to attempt recognition (with likely low accuracy) based on what can be heard, and later replace that text with the other user's more accurately recognized text. In any event, step 434 loops back until the conversation, or some part of the conversation is done.

Step 436 allows the user to review his or her own document before sending the text for merging into the transcription. This step also allows for any editing, such as to change text and/or redact text in part. Step 438 represents the user allowing or disallowing the merge, whether in whole or in part.

If allowed, step 440 sends the document to the other user for merging with that user's recognized text. Step 442 receives the other document for merging, merges it, and outputs it in some suitable way, such as a document or email thread for saving. Note that the receiving, merging and/or outputting at step 442 may be done at each user's machine, or at a central server.

In the post-transcription consent model, the sending at step 440 may be to an intermediary service or the like that only forwards the text if the other user's text is received. Some analysis may be performed to ensure that each user is sending corresponding text and timestamps that correlate, to avoid a user sending meaningless text in order to receive the other user's correct transcripts; an audio recording may ensure that the text can be recreated, manually if necessary. Merging may also take place at the intermediary, which allows matching up redacted portions, for example.

### Exemplary Operating Environment

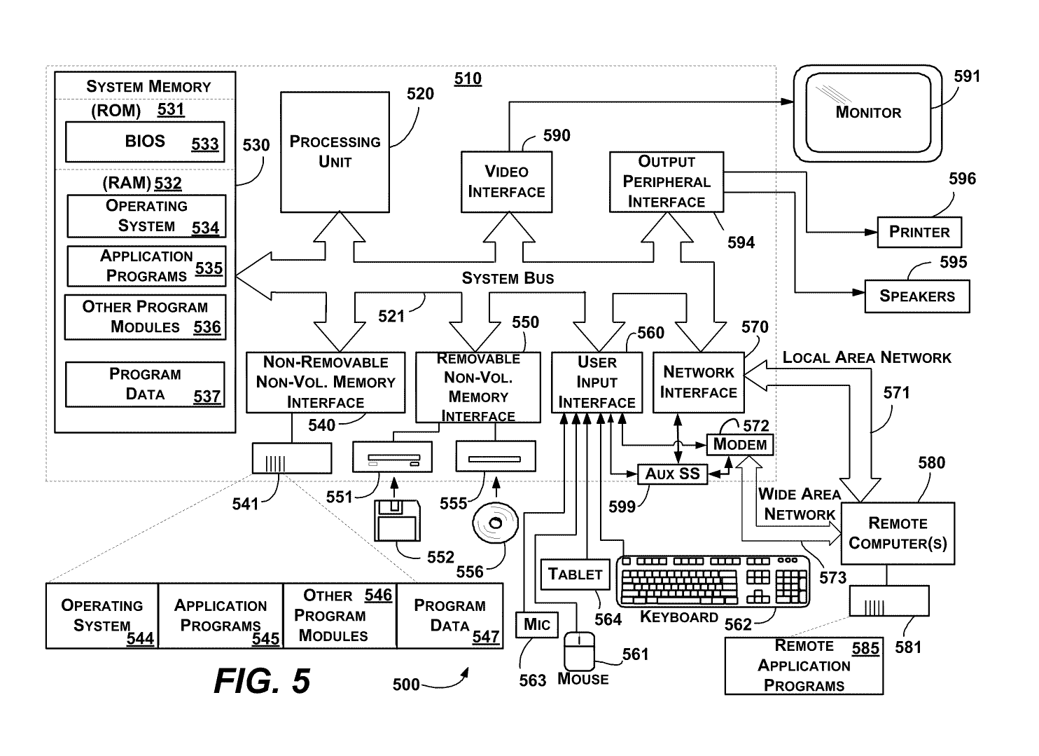

FIG. 5 illustrates an example of a suitable computing and networking environment 500 on which the examples of FIGS. 1-4B may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising:
receiving speech of a first user who is speaking with a second user;
recognizing the speech of the first user as text of the first user, independent of any transmission of that speech to the second user;
receiving text corresponding to speech of the second user, which was received and recognized as text of the second user separate from the receiving and recognizing of the speech of the first user; and
merging the text of text of the first user and the text of the second user into a transcript.

2. The method of claim 1 wherein recognizing the speech of the first user comprises using a recognition model for the first user that is based upon an identity of the first user.

3. The method of claim 1 wherein receiving the speech of the first user and recognizing the speech comprises using a microphone coupled to a personal computing device associated with that user.

4. The method of claim 1 further comprising, outputting the transcript, including providing labeling information that distinguishes the text of the first user from the text of the second user.

5. The method of claim 1 wherein merging the text of the first user and the text of the second user into the transcript occurs while a conversation is taking place.

6. The method of claim 1 wherein merging the text of the first user and the text of the second user into the transcript occurs after each user consents to the merging.

7. The method of claim 1 further comprising, outputting the transcript as a thread among a plurality of threads corresponding to a larger conversation.

8. The method of claim 1 further comprising, maintaining a recording of the speech of each user, and associating data with the transcript by which corresponding speech is retrievable from the recording of the speech.

9. In a computing environment, a system comprising:
a microphone set comprising at least one microphone that is configured to pick up speech of a single user;
a device coupled to the microphone set, the device configured to recognize the speech of the single user as recognized text independent of any transmission of the speech; and
a merging mechanism that merges the recognized text with other text received from at least one other user into a transcript.

10. The system of claim 9 wherein the microphone set is further coupled to a VoIP device configured for communication with each other user, and wherein the speech is transmitted via the VoIP device on a communication channel that is independent of a recognition channel that provides the speech to the recognizer.

11. The system of claim 9 wherein the microphone set comprises a highly-directional microphone array.

12. The system of claim 9 wherein the device is configured with a recognition model that is customized for the speech of the single user.

13. The system of claim 12 wherein the recognition model is maintained at a cloud service.

14. The system of claim 13 wherein the recognition model is accessible via the cloud service by at least one other device for use thereby in speech recognition.

15. The system of claim 9 wherein the merge mechanism comprises a transcription application running on the device or running on a central server.

16. The system of claim 9 wherein the device includes a user interface, wherein the merging mechanism dynamically merges the recognized text with the other text for outputting as the transcript via the user interface, and further comprising means for sending the recognized text of the single user to each other user.

17. The system of claim 9 wherein the device includes a user interface, and wherein the merging mechanism inserts a placeholder that represents where the other text is to be merged with the recognized text.

18. One or more computer-readable media having computer-executable instructions, which when executed perform steps, comprising:
receiving speech of a first user;
recognizing the speech of the first user as first text via a first recognition channel;
transmitting the speech to a second user via a transmission channel that is independent of the recognition channel;
receiving second text corresponding to recognized speech of the second user that was recognized via a second recognition channel that is separate from the first recognition channel; and
merging the first text and the second text into a transcript.

19. The one or more computer-readable media of claim 18 wherein merging the first text and the second text occurs while receiving further speech to dynamically provide the transcript.

20. The one or more computer-readable media of claim 18 having further computer-executable instructions comprising generating an email that includes the transcript, wherein the email comprises a thread among a plurality of threads corresponding to a larger conversation.
